(19) United States
(12) Patent Application Publication
(10) Pub. No.: US 2010/0038325 A1
(43) Pub. Date: Feb. 18, 2010

(54) METHOD AND APPARATUS FOR IMPROVING WATER QUALITY BY MEANS OF GASIFICATION

(76) Inventors: Steven Benson, Grand Forks, ND (US); Daniel J. Stepan, Grand Forks, ND (US); Richard Shockey, Emerado, ND (US); Nikhil Patel, Grand Forks, ND (US); Michael L. Swanson, Grand Forks, ND (US); Michael J. Holmes, Thompson, ND (US); Jaroslav Solc, Grand Forks, ND (US); Carsten Heide, Grand Forks, ND (US)

Correspondence Address: JOHNSON & ASSOCIATES, PO BOX 90698, AUSTIN, TX, 78709-0698, US

(21) Appl. No.: 12/305,635

(22) PCT Filed: Jun. 19, 2007
(86) PCT No.: PCT/US07/71594

§ 371 Date: Sep. 22, 2009

Related U.S. Application Data
(60) Provisional application No. 60/805,212, filed on Jun. 19, 2006.

(51) Int. Cl. C02F 1/58

(52) U.S. Cl. 210/766; 210/151

(57) ABSTRACT

A method and apparatus are provided for improving water quality using a gasification system. Whereas water is normally a deterrent to the combustion process, water is beneficial to the gasification of carbonaceous materials. The method and apparatus uses this, and other aspects, to utilize several processes to improve water quality by means of gasification in new and beneficial ways.

This application claims priority to copending, commonly owned U.S. patent application Ser. No. 60/805,212 filed on Jun. 19, 2006, entitled “AN APPARATUS FOR IMPROVING WATER QUALITY BY MEANS OF GASIFICATION.”

### BACKGROUND

In the following description, an apparatus and method for improving water quality by means of gasification is outlined.

Although combined desalination and power generation systems that utilize the heat from the combustion process are known in the art, this concept has never been expanded to be utilized in the integrated gasification combined-cycle (IGCC) and gasification to produce chemicals or fuels area. An IGCC system is a power plant using synthetic gas (syngas) as a fuel. In an IGCC system, more than one thermodynamic cycle is employed. For example, in a typical IGCC power plant, a gas turbine generates electricity, and the waste heat from the gas turbine is used to make steam to generate additional electricity using a steam turbine. This improves overall efficiency, compared to a gas turbine or steam turbine alone. The syngas produced from the gasification system can also be used to produce chemicals and synthetic fuels.

Whereas water is normally a deterrent to the combustion process, water is beneficial to the gasification of carbonaceous materials. The present invention uses this, and other aspects, to utilize several processes to improve water quality by means of gasification in new and beneficial ways.

### SUMMARY OF THE INVENTION

An apparatus of the invention is provided for improving water quality utilizing a gasification system, comprising a gasifier for gasifying a blend of a feedstock and a wastewater stream to produce a syngas, and a water recovery system for recovering improved quality water from the gasification system.

Another embodiment of the invention provides a method of improving the quality of wastewater using a gasification system, the method including blending a feedstock with wastewater and adding the blended feedstock and wastewater to a gasifier to produce a syngas to produce power as well as chemicals and fuels. The IGCC uses the syngas to power a gas turbine, using waste heat from the gasifier to power a steam turbine and recovering water from the vapor phase of the produced syngas and its combustion product stream. In the gasification system used to produce chemicals, waste heat from the gasifier can be recovered to produce steam.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of a water quality improvement system of the present invention.

### DETAILED DESCRIPTION

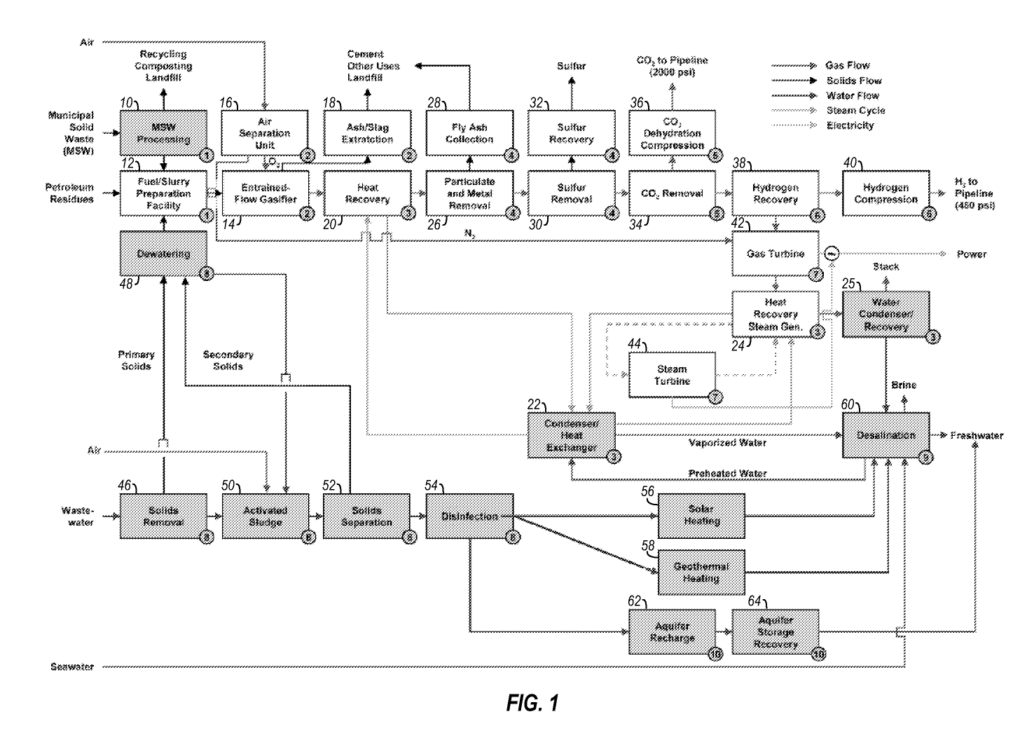

The following technical descriptions of the various components of the present invention are given as examples. Other embodiments and alternatives are possible. For example, depending on the feedstocks used (e.g., petroleum residues, coal, other hydrocarbons, biomass, etc.), different gasification processes may be utilized. Also, the system can function without the components needed for hydrogen or CO₂ recovery and other subsystems such as aquifer storage recharge (ASR), for example. Further, the gasification system can function without the electric power generating component and be used to produce syngas as a feedstock for chemicals and fuels production. FIG. 1 is a block diagram of a water quality improvement system of the present invention, including an IGCC system. In FIG. 1, various blocks include a circled numeral, which relates to the number in the numbered headings below.

### 1. Municipal Solid Waste (MSW) Processing and Fuel Preparation

In FIG. 1, the following blocks are related to this section: MSW Processing 10, Fuel/Slurry Preparation Facility 12.

Potential waste streams for consideration in the apparatus for improving water quality by means of gasification include any high-organic-content waste stream, which appears to be household waste, industrial waste, landscaping/green waste, and commercial waste (i.e., MSW). In addition, other feedstocks may be added to balance the right amount of carbonaceous material and water. Next to coal or petroleum coke, heavy petroleum residues can also make up the rest of the feed stream to a gasification system. Heavy bunker fuel, for example, can become the slurry feedstock with which to blend MSW. High-moisture sewage sludge is also a viable feedstock and is particularly well suited to control the moisture content of the slurry. Other types of wastewater streams may be considered, including industrial and petroleum-derived sludges. In the case of the latter, one of the major subsystems is the one that prepares and feeds the various feedstocks such as MSW, sewage sludge, and bunker oil to the gasifier 14 (e.g., Fuel/Slurry Preparation Facility 12).

For preparing the slurry mixture of MSW, sewage sludge, and bunker oil and feeding and entraining the slurry into the gasifier, the following unit operations can be incorporated into the feed system design (MSW processing 10):
Gravity separation—to remove glass, ceramic, rock, and ferrous items from the MSW that contribute to the wear of downstream unit operations such as mills, rotating equipment, and high-pressure feeders and pumps.
Size reduction—to reduce the MSW material from a nominal size of minus 10 cm to a size suitable for the type of gasifier to be utilized.
High-pressure feeding—to move the slurry at a controlled rate from ambient pressure to gasifier pressure (estimated to be between 400 and 450 psig) with either a pressurized solids feeder or high-pressure pumps.

Other unit operations that are desired are conveyors for transporting MSW between major processing steps, buffering/metering bins, and a system for measuring mass flow rate or providing totalized mass. Hydrothermal treatment is an option to improve the feed to an entrained-flow gasifier. Again, if utilized, this process is to be integrated within the heat recovery system of the plant to reduce costs.

### 2. Air Separation Unit/Gasifier/Slag Recovery

In FIG. 1, the following blocks are related to this section: Gasifier 14, Air Separation Unit 16, and Ash/Slag Extraction 18.

Based on the available feedstocks, a dry or slurry-fed gasifier set up to handle heavy residual materials is desired. All of the relevant gasification technologies are commercially proven technologies that should be able to easily convert the bunker fuel/MSW/sewage sludge feed to syngas from which any needed hydrogen can be extracted and power produced more efficiently than current boiler systems.

In one example, an entrained-flow quick-quench gasifier 14 operates under oxygen-blown conditions (e.g., the air separation unit 16 can provide oxygen to the gasifier 14). This is a high-temperature gasifier in which most of the fuel impurities are converted to a slag and removed from the gasifier (ash/slag extraction 18). The use of a high-temperature slagging entrained-flow gasification system will capture most of the metals from the MSW as a vitrified slag, ensuring simple disposal, and will also operate above 1100° C. for over 2 seconds to prevent the formation of hazardous species such as dioxins and furans which may otherwise form when MSW is utilized. Quick-quenching of the syngas streams has also been shown to reduce the reformation of these same hazardous species.

The fuel gas or synthesis gas produced in this example will have a heating value above 225 Btu/scf in an oxygen-blown mode. Oxygen-blown operation with a water quench system results in a syngas with higher compositions of H₂ and CO₂ because of the higher steam injection, leading to increased hydrogen production due to water-gas shifting. The slag produced from the system has a wide range of beneficial and safe uses such as road aggregate, roofing materials, abrasives, and concrete applications.

### 3. Syngas Cooler Heat Exchangers

In FIG. 1, the following blocks are related to this section: heat recovery 20, condenser/heat exchanger 22, heat recovery steam generator 24, and water condenser/recovery 25.

Boilers are used to cool the product gases prior to gas cleanup and reheat steam from the heat recovery steam generator 24 in the gas turbine exhaust stream. The steam produced is used to generate power in a steam turbine 44 (described below).

### 4. Gas Cleanup

In FIG. 1, the following blocks are related to this section: particulate and metal removal 26, fly ash collection 28, sulfur removal 30, and sulfur recovery 32.

Hot- and warm-gas cleanup is desired for the control of particulate and trace elements. Conventional and advanced sulfur control measures (e.g., sulfur removal and sulfur recovery systems 30 and 32) can be employed. The advanced high-temperature (>500° F.) methods, including the capture of the sulfur species, can be conducted in either a moving-bed or fluid-bed reactor by forming sulfides through the use of selected metal oxides. A series of metal oxides have been tested that include many of the transition metals such as iron oxide, zinc oxide, titanium oxide, copper oxide, and others. The components have the potential to be regenerated, and the sulfur can be recovered. It is anticipated that the moving bed would reduce the level of sulfur to less than the 10 ppm range. A second step would involve using a fixed bed to further reduce sulfur, other species such as halogens and, possibly, any mercury or other trace metals that remained. The sorbents to be utilized would include various metal oxides.

### 5. Carbon Dioxide Removal and Separation

In FIG. 1, the following blocks are related to this section: CO₂ removal 34 and CO₂ dehydration compression 36.

Conventional and advanced technologies for carbon dioxide separation (e.g., CO₂ removal 34) may be used with the present invention. The conventional methods include absorption-type processes such as monoethanol amine (MEA) and, to a lesser degree, Rectisol and Selexol. Advanced methods of carbon dioxide separation utilize CO₂ separation membranes that can tolerate higher operating temperatures. These would be utilized in conjunction with water-gas shift reactors to enhance hydrogen production through the water-gas shift equilibrium by removing one of the products from the shift reaction. Several of these membranes are currently under various stages of development. Additional separation options for CO₂ may be used, if appropriate.

This is the first step in a substantive greenhouse gas mitigation scenario and, in turn, to developing gas separation technologies that are market-ready. Subsequent steps are to compress, transport, utilize, and sequester CO₂ in oil and gas reservoirs to simultaneously improve hydrocarbon recovery and sequester CO₂ (e.g., CO₂ dehydration compression 36).

### 6. Hydrogen Recovery

In FIG. 1, the following blocks are related to this section: hydrogen recovery 38 and hydrogen compression 40.

As shown in FIG. 1, hydrogen is recovered (hydrogen recovery block 38), with some recovered hydrogen being provided to the gas turbine and some recovered hydrogen being compressed (hydrogen compression 40), if desired, and provided to a hydrogen pipeline or storage device. Conventional pressure swing absorption (PSA) is a proven technology for H₂ purification; however, advanced methods offer improved process efficiency. High-purity hydrogen separation can be conducted utilizing either metallic or ceramic membranes in the temperature range of 300°-500° C. Sulfur-tolerant Pd—Cu membranes are available capable of being utilized upstream of the final gas cooling and carbon dioxide separation. If cold-gas cleanup is utilized, hollow fiber polymeric membranes could also be employed downstream from the CO₂ separation step as long as extra-high-purity H₂ is not required. A new technology for gas separation called electrical swing adsorption has a significant possible advantage over PSA.

This technique employs an electrically conductive monolithic activated carbon adsorber that is regenerated by passing an electric current through it. The control of the desorption of the contaminate gas works so well that relatively pure individual streams of contaminates may be sequentially desorbed for more efficient alternate use or disposal. Hydrogen is particularly useful for upgrading petroleum or as an ultraclean fuel.

### 7. Combined Cycle

In FIG. 1, the following blocks are related to this section: gas turbine 42 and steam turbine 44.

In a combined-cycle gas turbine (CCGT) plant, a gas turbine 42 generator generates electricity. The output heat of the gas turbine flue gas is utilized to generate steam by passing it through a heat recovery steam generator (HRSG) 24 and, therefore, is used as input heat to the steam turbine 44 power plant. In the case of generating only electricity, power plant efficiencies are up to 50%. However, combining the HRSG 24 with the heat exchanger 22 of the desalination plant (described below), i.e., combined desalination and power generation, increases the efficiency to about 85%. To maximize water recovery, a water recovery system 25 utilizing a desiccant-based dehumidification system can be utilized in the recovery of the water from flue gas exiting the HRSG 24. Optionally, water can be condensed out of the gas stream using a heat exchanger 22 that simultaneously preheats the water on the water treatment side. One example of a desiccant-based water recovery system is described in detail in the following publication, which is incorporated by reference herein: “PRINCIPLES OF FLUE GAS WATER RECOVERY SYSTEM,” John H. Copen et al. POWER-GEN International 2005—Las Vegas, Nev., Dec. 6-8, 2005, pages 1-11.

### 8. Wastewater Treatment and Reclamation

In FIG. 1, the following blocks are related to this section: solids removal 46, dewatering 48, activated sludge 50, solids separation 52, disinfection 54, solar heating 56, and geothermal heating 58.

Limited availability of freshwater resources requires careful management and planning. Effective, integrated wastewater treatment and reclamation can provide not only the water required for energy production and makeup water for desalination, but could also provide water for numerous other beneficial uses, including aquifer recharge, municipal irrigation, agriculture, industry, and other nonpotable uses.

An integrated wastewater management strategy includes conventional activated sludge treatment (solids removal 46, activated sludge 50, and solids separation 52) to remove dissolved organic matter coupled with biosolids gasification and desalination of treated effluent. Primary solids in the influent to the activated sludge plant, along with secondary solids (waste activated sludge), would be dewatered (dewatering 48) and fed to the gasifier 14. Treated effluent from the activated sludge processes would be disinfected (disinfection 54) prior to use under several potential reuse scenarios. Used as makeup to a desalination plant, this effluent would be much more economical to treat because of lower dissolved solids content. Direct reuse opportunities might include aquifer recharge (described below), urban irrigation, agriculture, or numerous industrial uses.

Reduced desalination energy requirements can be realized by preheating disinfected wastewater via solar (solar heating 56), geothermal (geothermal heating 58), or gasification process heat exchange means (condenser/heat exchanger 22), prior to being used as feed water to the desalination process (desalination 60, described below).

Gas liquor (water condensed from the gasification process) can be used as cooling water for various unit operations in the gasification plant. The use of gas liquor allows the gasification plant to operate in a zero-liquid discharge mode. The heated liquor is directed to a cooling tower which evaporates water to the atmosphere, thereby cooling and concentrating the liquor. This dramatically reduces the volume of brine that must be disposed either by reinjection to the gasifier, incineration, or deep well injection. Heated gas liquor could also be routed to a desalination feed water/gas liquor heat exchanger to preheat desalination feed water prior to being directed to the cooling tower loop.

### 9. Desalination Technologies

In FIG. 1, the following blocks are related to this section: desalination 60.

A system of the present invention may use a water improvement system to treat water. One example of a water improvement system is a desalination unit (desalination 60). Three major thermal desalination processes are in use that could directly utilize the heat generated from the gasification process: multistage flash (MSF) desalination, multiple effect evaporation (MEE), and mechanical vapor compression (MVC). In the MSF and MEE processes, steam extracted from the low- and medium-pressure turbine lines provides the heat necessary for flashing or evaporation of feed water. MVC is distinguished from the other processes by the presence of a mechanical vapor compressor, which compresses the vapor formed within the evaporator to the desired pressure and temperature. The vapor in all three processes is condensed to produce low-salt freshwater. Novel desalination processes based on freeze crystallization may also be employed. The freezing of water requires one-seventh the energy of vaporization. Multistage, countercurrent freeze crystallization shows promise of a greatly reduced energy requirement over vaporization processes and would potentially utilize heat indirectly from the gasification process.

### 10. Aquifer Storage Recharge (ASR) and Recovery

In FIG. 1, the following blocks are related to this section: aquifer recharge 62 and aquifer storage recovery 64.

Artificial recharge (aquifer recharge 62) is a human-induced, planned, and managed storage of treated water in suitable aquifers and its recovery (aquifer storage recovery 64) when water is needed. Integrated into existing infrastructure and water management strategies, artificial recharge and ASR, in particular, represent a true “waterbanking” concept to meet both the short- and long-term water management needs of various arid countries.

Using dual-purpose (or ASR) wells for both recharge and recovery of treated water stored during periods of seasonal or off-peak surplus, the ASR concept has experienced growing recognition and application in a variety of freshwater, brackish, and saline aquifer settings. ASR can be easily integrated into existing water treatment facilities or within the distribution system and become a flexible tool to address increased water demands in the overall water management scheme or to provide a source of supply in times of critical shortage. Combined with conjunctive water management, ASR can also be used for long-term replenishment to sustain pumping rates while protecting aquifer water quality. Among numerous other benefits of induced aquifer recharge, ASR technology addresses a critical issue common to water suppliers by balancing periods of surplus and water shortage. In addition, it may prevent water quality deterioration resulting from pumping in areas with insufficient natural recharge. A steady decrease of aquifer pressure typically results in an increased flux of saline water from surrounding formations, with potentially serious impacts on groundwater quality.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. An apparatus for improving water quality utilizing a gasification system, comprising
a gasifier for gasifying a blend of a feedstock and a wastewater stream to produce a syngas and
a water recovery system for recovering improved quality water from the gasification system.

2. The apparatus of claim 1, further comprising a water improvement system, wherein heat from the gasifier is utilized by the water improvement system.

3. The apparatus of claim 2, wherein the water improvement system is a desalination unit.

4. The apparatus of claim 2, wherein the gasification system includes a heat recovery system, the apparatus further comprising a desiccant-based water recovery system to remove water from the gas stream.

5. The apparatus of claim 2, wherein the gasification system includes a heat recovery system, the apparatus further comprising a heat exchanger to condense water from the gas stream while preheating water introduced to the water improvement system.

6. The apparatus of claim 3, further comprising using a solar heat source to preheat feed water to the desalination unit to increase the thermal efficiency of the desalination process.

7. The apparatus of claim 2, further comprising using a solar heat source to preheat feed water to the desalination unit to increase the thermal efficiency of the water improvement process.

8. The apparatus of claim 3, further comprising using a geothermal heat source to preheat feed water to the desalination unit to increase the thermal efficiency of the water improvement process.

9. The apparatus of claim 3, further comprising using a geothermal heat source to preheat feed water to the desalination unit to increase the thermal efficiency of the desalination process.

10. The apparatus of claim 1, wherein the water recovery system recovers water from the produced syngas and its combustion product stream.

11. The apparatus of claim 8, wherein the water recovered from the produced syngas is run through a water improvement system.

12. The apparatus of claim 9, wherein the water improvement system includes a desalination unit.

13. The apparatus of claim 1, wherein the wastewater stream is a municipal solid waste or industrial waste stream.

14. The apparatus of claim 1, wherein the feedstock includes petroleum residues.

15. The apparatus of claim 1, wherein the feedstock includes coal.

16. The apparatus of claim 1, wherein the feedstock includes biomass.

17. A method of improving the quality of wastewater using an integrated gasification combined-cycle (IGCC) system, the method comprising
blending a feedstock with wastewater
adding the blended feedstock and wastewater to a gasifier to produce a syngas used to power a gas turbine
using waste heat from the gasifier to power a steam turbine and
recovering water from the vapor phase of the produced syngas and its combustion product stream.

18. The method of claim 17, further comprising desalinating water using heat from the gasifier.

19. The method of claim 17, wherein the waste heat from the gasifier is recovered using a desiccant-based water recovery system.

20. The method of claim 17, wherein the waste heat from the gasifier is recovered using a heat exchanger to condense water from the gas stream while preheating water to be introduced to a water treatment system.

21. The method of claim 17, further comprising using a solar heat source to preheat water to be introduced to a water treatment system to increase the thermal efficiency of the treatment process.

22. The method of claim 17, further comprising using a geothermal heat source to preheat water to be introduced to the water treatment system to increase the thermal efficiency of the treatment process.

23. The method of claim 17, wherein the wastewater is taken from a municipal solid waste or industrial waste stream.

24. The method of claim 17, wherein the feedstock includes petroleum residues.

25. The method of claim 17, wherein the feedstock includes coal.

26. The method of claim 17, wherein the feedstock includes biomass.
